(19) United States
(12) Patent Application Publication
(10) Pub. No.: US 2023/0373760 A1
(43) Pub. Date: Nov. 23, 2023

(54) DEVICES, SYSTEMS, AND METHODS FOR TRANSPORTING AND POURING GRAVEL OR OTHER FILL MATERIAL INTO OR ONTO A DESIRED LOCATION

(71) Applicant: Gary Swartout, Mooresville, IN (US)

(72) Inventor: Gary Swartout, Mooresville, IN (US)

(21) Appl. No.: 18/200,142

(22) Filed: May 22, 2023

Related U.S. Application Data
(60) Provisional application No. 63/344,397, filed on May 20, 2022.

(51) Int. Cl. B66C 3/00

(52) U.S. Cl. CPC B66C 3/00

(57) ABSTRACT

Devices, systems, and methods for transporting and pouring gravel or other fill material into or onto a desired location. The present disclosure includes disclosure of a container device, comprising a first side wall and a second side wall, each coupled to or formed along with a rear wall, a bottom wall coupled to the first side wall, the second side wall, and the rear wall, and a front wall directly or indirectly coupled to the first side wall and the second side wall, the front wall defining an arcuate pour profile.

### PRIORITY

The present patent application is related to, and claims the priority benefit of, U.S. Provisional Patent Application Ser. No. 63/344,397, filed May 20, 2022, the contents of which are incorporated herein directly and by reference in their entirety.

### BRIEF SUMMARY

The present disclosure includes disclosure of a device configured to receive gravel or other fill material, be transported, and be tilted to pour said gravel or other fill material into or onto a desired location, according to at least one embodiment.

The present disclosure includes disclosure of a system configured to utilize a bucket device configured to receive gravel or other fill material, be transported, and be tilted to pour said gravel or other fill material into or onto a desired location, according to at least one embodiment.

The present disclosure includes disclosure of a method of using a device and/or system, according to at least one embodiment.

The present disclosure includes disclosure of a container device, comprising a first side wall and a second side wall, each coupled to or formed along with a rear wall, a bottom wall coupled to the first side wall, the second side wall, and the rear wall, and a front wall directly or indirectly coupled to the first side wall and the second side wall, the front wall defining an arcuate pour profile.

The present disclosure includes disclosure of a container device, wherein the front wall is directly coupled to the first side wall and the second side wall.

The present disclosure includes disclosure of a container device, wherein the front wall is indirectly coupled to the first side wall and the second side wall by way of a first transition wall and a second transition wall, such that the front wall is coupled to the first transition wall and the second transition wall, such that the first transition wall is coupled to the first wall, and such that the second transition wall is coupled to the second wall.

The present disclosure includes disclosure of a container device, configured to be positioned upon part of a hauler machine.

The present disclosure includes disclosure of a container device, whereby the first side wall, the second side wall, and the rear wall are each tapered downward.

The present disclosure includes disclosure of a container device, further comprising a plurality of connection loops coupled thereto or formed as part thereof.

The present disclosure includes disclosure of a container device, wherein each connection loop of the plurality of connection loops is configured to receive a hook or a loop of a chain or a cable.

The present disclosure includes disclosure of a container device, further comprising a plurality of connection bars coupled thereto or formed as part thereof.

The present disclosure includes disclosure of a container device, wherein each connection bar of the plurality of connection bars is configured to receive a hook or a loop of a chain or a cable.

The present disclosure includes disclosure of a container device, further comprising a plurality of connection apertures defined therein.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a front perspective view of a bucket device, according to at least one exemplary embodiment of the present disclosure;

FIG. 2 shows the bucket device of FIG. 1 with dashed lines to depict the non-visible portions of said device, according to at least one exemplary embodiment of the present disclosure;

FIG. 3 shows a front perspective view of another embodiment of a bucket device, according to at least one exemplary embodiment of the present disclosure;

FIG. 4 shows a top-down view of the bucket device of FIG. 3, according to at least one exemplary embodiment of the present disclosure;

FIG. 5 shows a bucket device positioned upon a hauler machine, according to at least one exemplary embodiment of the present disclosure;

FIG. 6 shows a front perspective view of a bucket device having connection loops and connection bars, according to at least one exemplary embodiment of the present disclosure;

FIG. 7 shows a front perspective view of a bucket device having connection apertures and connection bars, according to at least one exemplary embodiment of the present disclosure;

FIG. 8 shows a rear perspective view of a bucket device showing connection bars, and

FIG. 9 shows a bucket device being tipped so to deliver gravel or other fill material within a hole surrounding at least part of a utility pole.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of systems, devices, and methods for transporting and pouring gravel or other fill material or other objects into or onto a desired location.

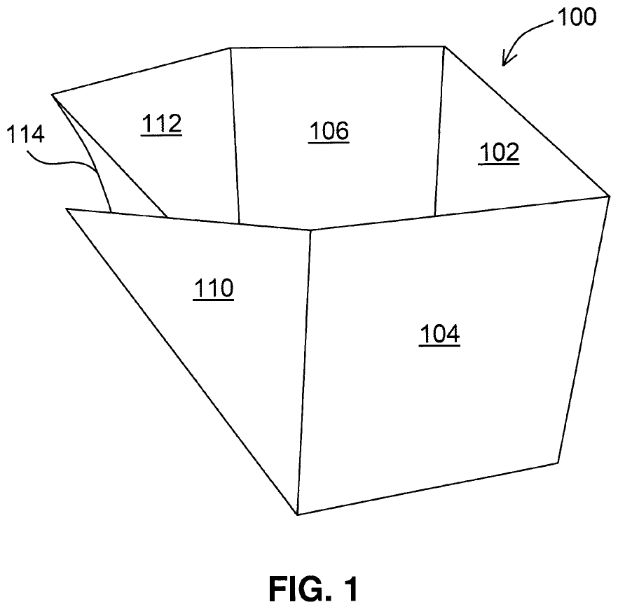

An exemplary bucket device 100 of the present disclosure is shown in FIG. 1. As shown in FIG. 1, bucket device 100 is configured as a container so that it may receive gravel, other filler material, or other objects therein, including, but not limited to, gravel, soil, sand, concrete, cement, and the like, used to backfill a utility pole ground hole.

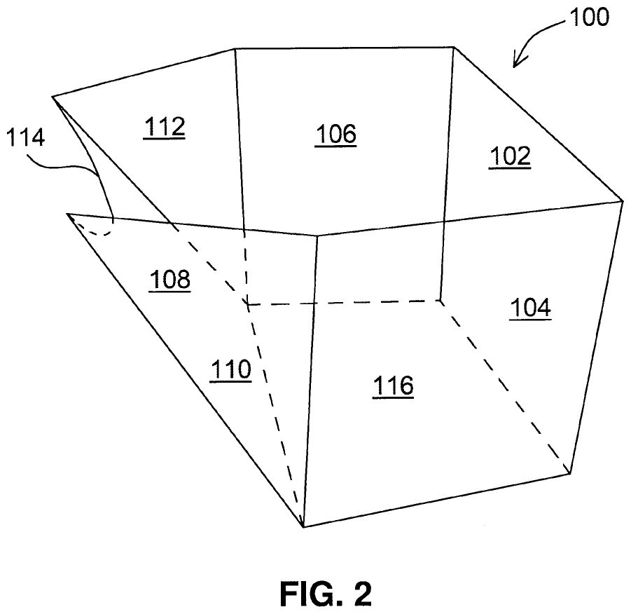

Exemplary embodiments of bucket devices 100 of the present disclosure can include various features as shown and/or described herein. For example, and as shown in FIG. 1, an exemplary bucket device 100 of the present disclosure can comprise a plurality of walls, such as a rear wall 102, a first side wall 104 coupled to or formed along with rear wall 102, a second side wall 106 coupled to or formed along with rear wall 102, and a front wall 108 (shown in FIG. 2, for example), which can be directly coupled to or formed along with first side wall 104 and/or second side wall 106, or, as shown in FIG. 1, indirectly coupled thereto by way of a first transition wall 110 coupled to or formed along with front wall 108 and first side wall 104, and a second transition wall 112, coupled to or formed along with front wall 108 and second side wall 106.

Front walls 108 of bucket devices 100 of the present disclosure have an arcuate pour profile 114, such as shown in FIG. 1. Arcuate pour profile 114 is sized and shaped (configured) to generally mirror or align with the curved profile of a utility pole and/or a round hole having a portion of said utility pole positioned therein, so that when bucket device 100 is tilted/tipped so to pour gravel or other fill material from therein, the gravel or other fill material is poured along said arcuate pour profile 114, falling in between the curved profile of the utility pole and the curved profile of a round hole, efficiently directing the poured gravel or other fill material into the remaining hole opening not occupied by the portion of the utility pole itself.

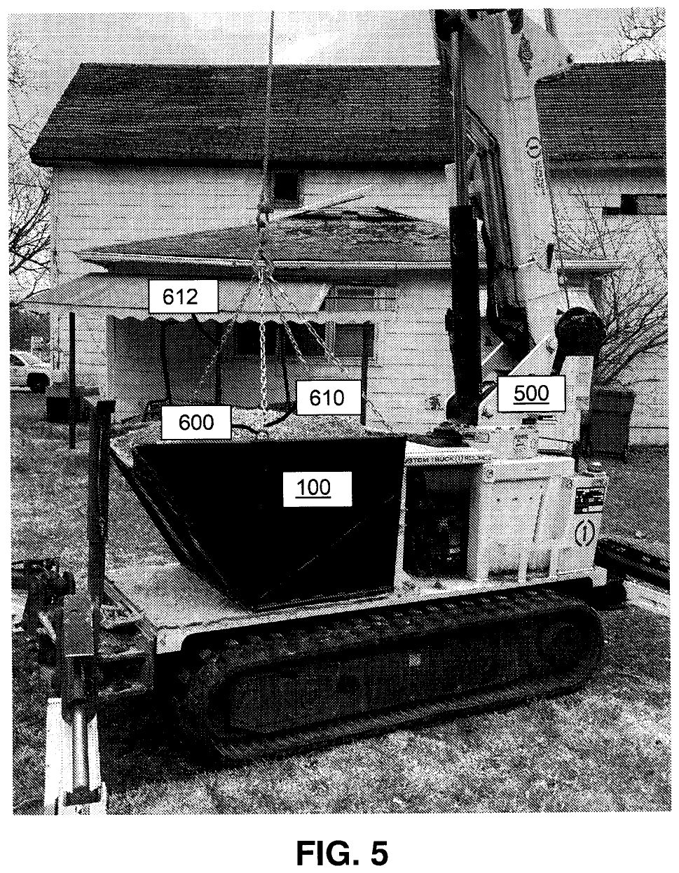

Procedurally, bucket devices 100 of the present disclosure can be filled with gravel or other fill material, for example, and be placed upon a hauler machine 500, such as shown in FIG. 5. Hauler machines 500 of the present disclosure may refer to various types of tracked machines, such as backyard digger derricks configured to fit within 36″ wide fence gates, or larger or smaller machines, such as full-sized digger derricks, used on roadways and areas not requiring a smaller machine 500. Gravel or other fill material can be placed within bucket device 100 prior to loading said device upon hauler machine 500, or it can be placed upon bucket device 100 and then filled with gravel or other fill material.

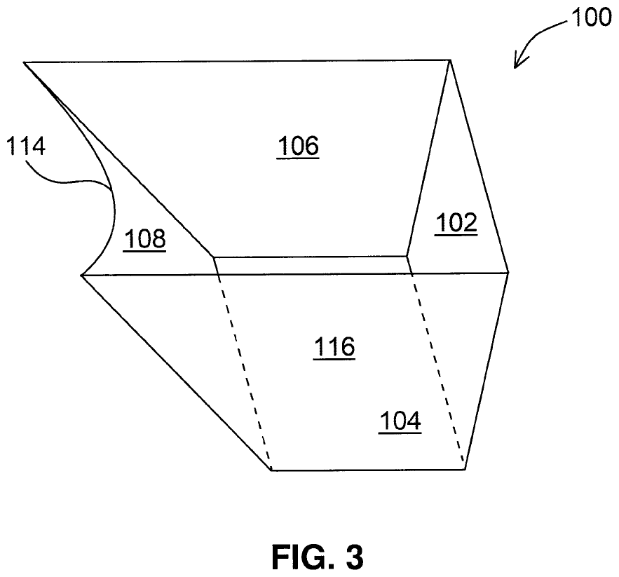

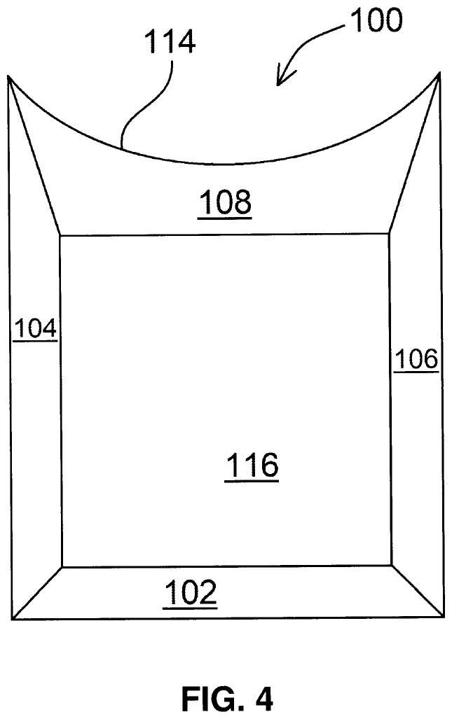

Bucket devices 100 of the present disclosure can have tapered rear walls 102, first side walls 104, and/or second side walls 106, such as shown in FIGS. 1 and 2. Such an embodiment would allow for more gravel or other fill material to be placed within said bucket devices 100 having a same overall height and bottom wall 116 dimension as bucket devices with straight (or non-tapered) sides, such as shown in the bucket device 100 embodiments shown in FIGS. 3 and 4.

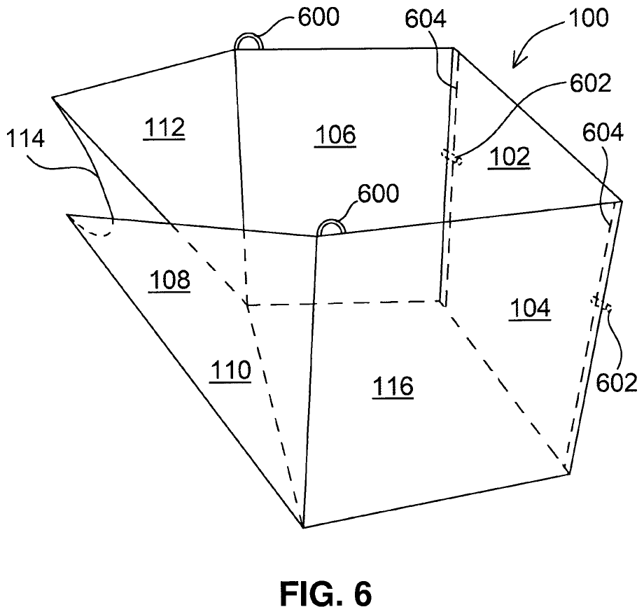

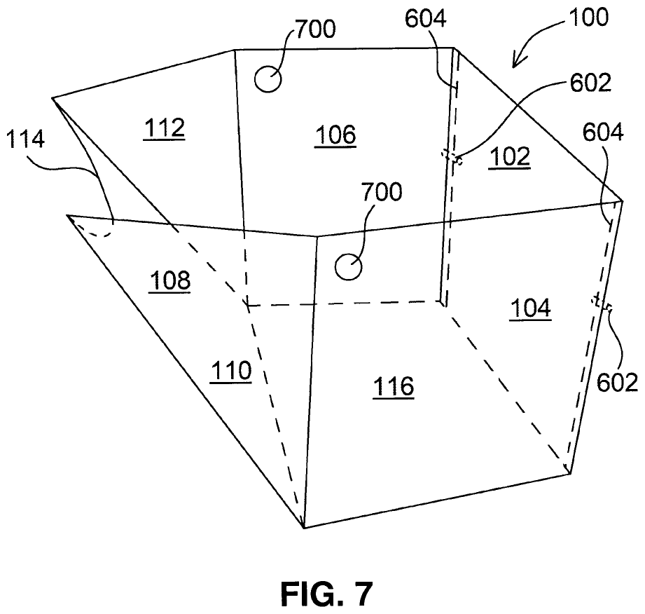

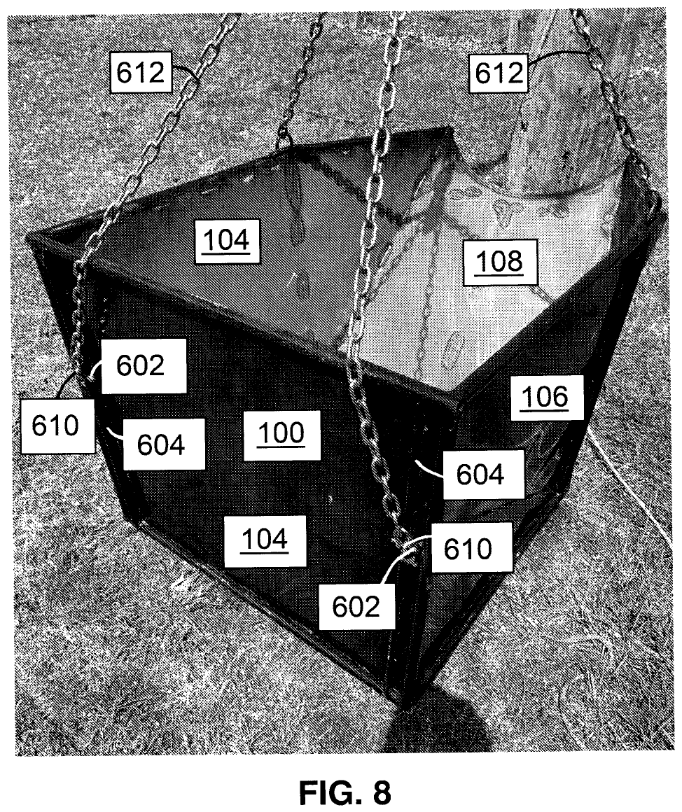

As shown in FIG. 6, an exemplary bucket device 100 of the present disclosure can have a plurality of connection loops 600 (such as shown in FIG. 6) and/or connection bars 602 (such as shown in FIGS. 7 and 8) coupled thereto or formed as part thereof. Connection loops 600 would be sized and shaped (configured) to each receive a hook or loop 610 of a chain or cable 612, whereby hauler machine 500 (such as shown in FIG. 5) could lift bucket device 100 and position it thereon by lifting chains or cables 612 coupled to the bucket device 100. Connection bars 602 could be, for example, a threaded or non-threaded fastener positioned within fastener openings defined within portions of bucket device 100, such as within support ribs 604 as shown in FIG. 6, as well as within extension portions of various walls, such as, for example, first side wall 104 and second side wall 106.

In at least another embodiment, and such as shown in FIG. 7, an exemplary bucket device 100 of the present disclosure can have one or more connection apertures 700 defined therein, whereby said connection apertures 700 a would be sized and shaped (configured) to each receive a hook or loop 610 of a chain or cable 612, whereby hauler machine 500 could lift the bucket device 100 and position it thereon by lifting chains or cables 612 coupled to bucket device 100.

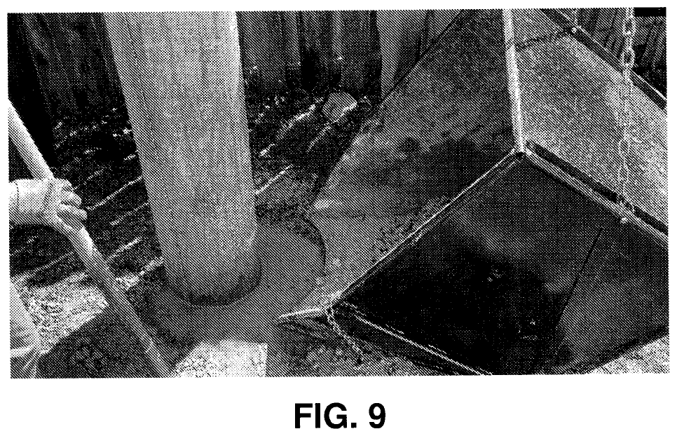

Bucket devices 100 of the present disclosure are specially configured so to allow said devices 100 to be filled with gravel or other fill material, lifted by a hauler machine 500 and positioned thereon, transported to a location at or near a utility pole, lifted by hauler machine 500 and positioned on the ground, and tipped so that the gravel or other fill material can pour out of said device 100 at the arcuate pour profile 114 to allow for directed gravel or other fill material delivery around said utility pole, such as shown in FIG. 9. The configuration/positioning of connection bars 602 on the relative back of bucket device 100 lower than the relative top of said device 100, in at least one embodiment, allows for chains or cables 612 to connect thereto to more readily direct tipping of said device to pour the gravel or other fill material as desired.

While various embodiments of systems ad devices for transporting and pouring gravel or other fill material and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A container device, comprising:
a first side wall and a second side wall, each coupled to or formed along with a rear wall;
a bottom wall coupled to the first side wall, the second side wall, and the rear wall; and
a front wall directly or indirectly coupled to the first side wall and the second side wall, the front wall defining an arcuate pour profile.

2. The container device of claim 1, wherein the front wall is directly coupled to the first side wall and the second side wall.

3. The container device of claim 1, wherein the front wall is indirectly coupled to the first side wall and the second side wall by way of a first transition wall and a second transition wall, such that the front wall is coupled to the first transition wall and the second transition wall, such that the first transition wall is coupled to the first wall, and such that the second transition wall is coupled to the second wall.

4. The container device of claim 1, configured to be positioned upon part of a hauler machine.

5. The container device of claim 1, whereby the first side wall, the second side wall, and the rear wall are each tapered downward.

6. The container device of claim 1, further comprising a plurality of connection loops coupled thereto or formed as part thereof.

7. The container device of claim 6, wherein each connection loop of the plurality of connection loops is configured to receive a hook or a loop of a chain or a cable.

8. The container device of claim 1, further comprising a plurality of connection bars coupled thereto or formed as part thereof.

9. The container device of claim 8, wherein each connection bar of the plurality of connection bars is configured to receive a hook or a loop of a chain or a cable.

10. The container device of claim 1, further comprising a plurality of connection apertures defined therein.
